(19) United States
(12) Patent Application Publication
(10) Pub. No.: US 2023/0402964 A1
(43) Pub. Date: Dec. 14, 2023

(54) AUTONOMOUS DYNAMIC CLEANING SYSTEM FOR PHOTOVOLTAIC PANELS AND METHOD THEREOF

(71) Applicants: Suraj MOHAN, Chennai (IN); Prashant GOEL, Coimbatore (IN); Surandhar S, Thiruvallur (IN); Prabhakaran RAJAMANI, Dindigul (IN); Vikas DWIVEDI, Nagpur (IN)

(72) Inventors: Suraj MOHAN, Chennai (IN); Prashant GOEL, Coimbatore (IN); Surandhar S, Thiruvallur (IN); Prabhakaran RAJAMANI, Dindigul (IN); Vikas DWIVEDI, Nagpur (IN)

(21) Appl. No.: 18/035,268

(22) PCT Filed: Nov. 3, 2021
(86) PCT No.: PCT/IN2021/051049

§ 371 Date: May 3, 2023

(30) Foreign Application Priority Data
Nov. 3, 2020 (IN) 202041048031

(51) Int. Cl. H02S 40/10; B08B 1/04; F24S 40/20; G16Y 40/35

(52) U.S. Cl. CPC H02S 40/10; B08B 1/04; F24S 40/20; G16Y 40/35

(57) ABSTRACT

The present invention discloses a system for an autonomous, dynamic cleaning system for photovoltaic panels and a method thereof. The system comprises an autonomous solar bot (100) for cleaning PV panels (202) in a solar plant (200), where the solar bot (100) is capable of re-orientation, dynamic path-tracing as well as predictive cleaning. The solar bot (100) comprises specialized mecanum wheels for enabling enhanced movement across the PV panels (202). The invention also provides a system and method for a solar plant cleaning system (300) which uses drones (204) to transport the solar bot (100), and which can be controlled through fleet control via an IoT dashboard (426). Further, the IoT dashboard (426) may also be used for solar plant management.

### FIELD OF INVENTION

The field of invention generally relates to solar plant cleaning systems. More specifically, it relates to an autonomous dynamic cleaning system comprising a solar bot for cleaning photovoltaic panels.

### BACKGROUND

Solar power, being one of the most widely available renewable sources of energy, has seen immense interest and progress. In particular, photovoltaic panels or PV panels are being widely installed for both commercial as well as personal use. PV panels are expensive to replace, and require considerable maintenance. If the top layer of the PV panels accumulates dust/dirt/other droppings, the efficiency of the PV panels is affected negatively. Hence, PV panels require regular, thorough cleaning while ensuring that the top layer is not damaged. Robots provide a novel way for cleaning PV panels effectively.

Some current cleaning robots are largely based on being controlled remotely by a user (through an RF remote control) and are semi-autonomous comprising online tracer/edge tracer or colour detection technology. There also exist some autonomous robots that work by using suction cups.

The problems with existing technology are that with remotes, there is still a large dependency on human manual intervention, which is not feasible in large plants where continuous control of the robot is required. Other systems have tried to address this with semi-autonomous robots, where a separate infrastructure needs to be created for the bot to function, such as affixing a frame onto the PV panels or painting the edges with certain color codes, etc. Hence, the current semi-autonomous robots are still reliant on additional hardware, which is not convenient.

Other current systems use suction cups, which are typically extremely heavy and frequently damage the glass top of the PV panels. The movement of robots with suction cups is slow, and thus such robots need a longer duration to clean large scale PV plants. Additionally, in cases of windy/bad weather, such robots may be pushed off their pre-determined paths, which is causes errors in the functioning of the robot, and increases chances of the robot falling off the PV panel.

Thus, in light of the above discussion, it is implied that there is need for a system and method for autonomous, dynamic cleaning of PV panels, which is reliable and does not suffer from the problems discussed above.

### OBJECT OF INVENTION

The principle object of this invention is to provide a system for an autonomous dynamic cleaning system for photovoltaic panels and a method thereof.

A further object of the invention is to provide a system and method for a solar bot which has a modular design with portability and instant assembly.

Another object of the invention is to provide a system and method for a solar bot which displays improved re-orientation and movement across the PV panels.

Another object of the invention is to provide a system and method for a solar bot which has specialized mecanum wheels or crawler wheels for enhanced movement across the PV panels

Another object of the invention is to provide a system and method for a solar cleaning system which provides dynamic mapping, which ensures efficient functioning of the robot in any scenario irrespective of layout, obstructions, and gaps.

Another object of the invention is to provide a system and method for a solar cleaning system with predictive cleaning functions.

Another object of the invention is to provide a system and method for a solar cleaning system which has drone transport as well as fleet control via IoT (using NB-IoT, LoRa, or WiFi, among other communication/fleet management technologies), for enabling real-time connectivity, monitoring and analytics of the fleet.

Another object of the invention is to provide a system and method for a solar cleaning system which provides a dashboard for solar plant management.

### BRIEF DESCRIPTION OF FIGURES

This invention is illustrated in the accompanying drawings, throughout which, like reference letters indicate corresponding parts in the various Figures.

The embodiments herein will be better understood from the following description with reference to the drawings, in which:

FIG. 1 depicts/illustrates an autonomous solar bot, in accordance with an embodiment:

FIG. 2 depicts/illustrates the autonomous solar bot being used in a solar plant with a deployed drone, in accordance with an embodiment;

FIG. 3 depicts/illustrates components of an autonomous PV panel cleaning system, in accordance with an embodiment:

FIG. 4 depicts/illustrates block diagrams depicting the components of an autonomous PV panel cleaning system, in accordance with an embodiment;

FIG. 5 depicts/illustrates an autonomous PV panel cleaning process with a docking station, in accordance with an embodiment;

FIG. 6 illustrates a method for autonomous PV panel cleaning, in accordance with an embodiment;

FIG. 7 illustrates a method for drone deployment in a solar plant, in accordance with an embodiment;

FIG. 8 depicts/illustrates an isometric view of an autonomous solar bot, in accordance with an embodiment:

FIG. 9 depicts/illustrates an isometric view of an autonomous solar bot, in accordance with an embodiment;

FIG. 10 depicts/illustrates a side view of an autonomous solar bot, in accordance with an embodiment;

FIG. 11 depicts/illustrates a front view of an autonomous solar bot, in accordance with an embodiment.

### STATEMENT OF INVENTION

The present invention provides a system and method for dynamic autonomous cleaning of a PV panel. The system comprises an autonomous solar bot for cleaning PV panels in a solar plant, where the solar bot comprises cleaning brushes that create friction on the PV panels by rotating in clockwise and anti-clockwise directions, and mecanum wheels or crawler wheels for ensuring even surface load-distribution over the surface of upper most glass layer of the PV panel. Further, the system comprises various sensors, wherein the solar bot gathers information from said sensors to predict whether a cleaning is required on any PV panels in the solar plant. Furthermore, the system comprises an IoT server which uses at least one of NB-IoT, LoRa, and WiFi, among other communication/fleet management technologies. Further, the server is configured to receive instructions from the solar bot and provide fleet control by communicating with one or more drones in the solar plant to identify the closest drone which is near a PV panel that requires cleaning.

The cleaning function is monitored through an IoT dashboard by a user. Either new actions are initiated or existing actions of the solar bot are modified by the user, wherein the IoT dashboard displays information read by the sensors of the solar bot, as well as solar power generation data of each PV panel of the solar plant. Further, upon receiving instruction to initiate the cleaning process, the solar bot moves upwards from either left or right corner at the bottom of the PV array. After reaching the top edge of a column in the array, the solar bot determines a starting edge. Further, the solar bot moves downwards by turning ON the brush motor to initiate the cleaning of said column. Subsequently, the solar bot detects the bottom edge and moves upwards. Upon reaching the top edge for the second time, the solar bot shifts sideways using intuitive turning mechanism through artificial intelligence until next column is detected. The cleaning cycle is repeated for all the columns in the PV array, wherein the solar bot is returned to a base position or a docking station upon cleaning all the columns of the PV array. The solar bot is further picked up by a drone to transfer said solar bot onto another PV array, in case cleaning is required on said PV array.

### DETAILED DESCRIPTION

The embodiments herein and the various features and advantageous details thereof are explained more fully with reference to the non-limiting embodiments that are illustrated in the accompanying drawings and/or detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The present invention discloses a system for an autonomous, dynamic cleaning system for photovoltaic (PV) panels and a method thereof. The system comprises an autonomous solar bot for cleaning PV panels in a solar plant, where the solar bot is capable of re-orientation, dynamic path-tracing as well as predictive cleaning. The solar bot comprises at least one of specialized mecanum wheels, crawler wheels, and caterpillar wheels, for enabling enhanced movement across the PV panels. The invention also provides a system and method for a solar plant cleaning system which uses drones to transport the solar bot, and which can be controlled through fleet control via an IoT dashboard. Further, the IoT dashboard may also be used for solar plant management.

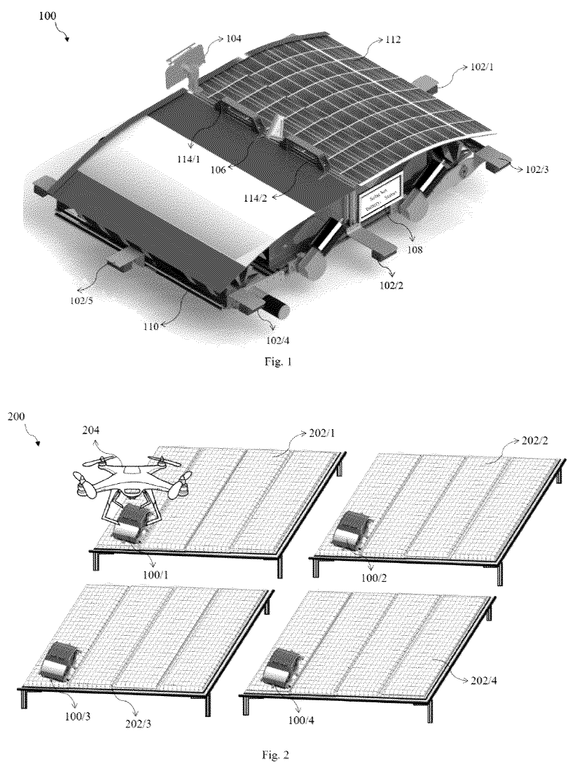

FIG. 1 depicts/illustrates an autonomous solar panel cleaning bot 100, in accordance with an embodiment. The autonomous solar panel cleaning bot 100 is hereinafter referred to as solar bot 100.

The solar bot 100 may be used to clean PV panels in a solar array setup comprising one or more PV panels. The solar bot 100 may also be deployed in a solar plant comprising a large number of PV panels (not depicted in figure).

In an embodiment, some of the components of the solar bot are depicted in FIG. 1. The solar bot 100 may comprise multiple sensors 102, a holder 104 for attaching a camera or a thermal camera, a tower light 106, a display 108, multiple brush motors 110, an onboard PV panel 112, and one or more handles 114, as well as a power switch and an emergency stop switch. The solar bot 100 is enabled for efficient cleaning of photovoltaic panels by using one or more rotating brushes by using dynamic path mapping, fully autonomous motion as well as predictive cleaning initiation.

In an embodiment, the solar bot 100 uses several Artificial Intelligence and sensor technology to ensure that the solar bot 100 can be used in any solar plant site, irrespective of layout, obstruction, or gaps.

In an embodiment, the solar bot 100 is portable and can be easily moved from one solar array to another, or to different locations by using the one or more handles 114, which may be permanent or removable as per user requirement. Further, Fleet control via IoT and electronics

In an embodiment, the solar bot 100 comprises two cylindrical cleaning brushes which are placed at a front end and at a rear of the solar bot 100. The brushes may be driven by brush motors 110, and may be used in both dry and wet conditions of the PV panel. The cleaning brushes may comprise at least one of a fabric, cloth, sponge, and microfiber brushes.

In an embodiment, an additional water supply may be provided by using a hose connected to the solar bot 100, as required by the user.

In an embodiment, chassis of the solar bot 100 comprises one or more light weight metals to reduce the overall weight of the solar bot 100. In an embodiment, at least one of metal profiles, metal flats and anodized aluminum profile sections may be used to build the chassis. The chassis may be aerodynamically designed to optimize the speed and movement of the solar bot 100 on the PV panel 202.

In a preferred embodiment, the solar bot 100 comprises four mecanum wheels or crawler wheels, which are in turn driven by one or more DC motors. The DC motor may comprise a PMDC or a BLDC motor.

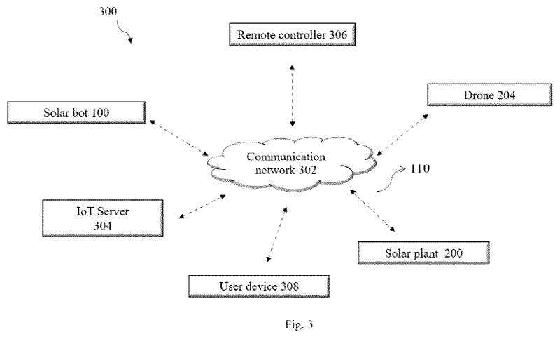

FIG. 2 depicts/illustrates the autonomous solar bot 100 being used in a solar plant 200 with a deployed drone 204, in accordance with an embodiment. The figure depicts an exemplary embodiment where the solar plant 200 may comprise 4 sets of PV panels 202/1-202/4. The number of PV panels 202 in the solar plant 200 may be increased or decreased as per the user requirement.

In an embodiment, the solar plant 200 may comprise one or more PV panels 202, a PV plant sensor unit and a communication module.

In an embodiment, the PV plant sensor may comprise one or more of weather sensors, pyranometers, humidity sensors and temperature sensors, among others. The information collected by the sensors may be communicated with one or more other components of the cleaning system through a communication network (not shown in figure).

In an embodiment, the solar bot 100 may analyze one or more information received from the PV plant sensor unit to execute a new action or modify a current action. As an example, one or more received weather information may be analyzed and, in case rainy weather is detected, the solar bot 100 may pause a current cleaning action and return to a base position or a docking station (not shown in figure).

In an embodiment, multiple PV panels 202 may form a solar PV array, where each PV array may be cleaned by a separate solar bot 100.

In an embodiment, certain solar plants may comprise a large number of PV arrays, where using a separate solar bot 100 for each PV array is not cost-effective. In another case, certain solar plants may comprise fewer solar arrays that can be efficiently cleaned by a lesser number of solar bots 100. In such cases, multiple solar bots 100 may be shared between a group of PV arrays, such that the number of solar bots 100 is less than the number of PV arrays in the solar plant 200.

In an embodiment, one or more drones 204 may be used for GPS/mapping-based table to table movement of the solar bot 100. Thereafter, the drones 204 may be used to transfer solar bots 100 from one PV array to another, in other to clean all the PV panels 202 in the PV plant 200.

FIG. 3 depicts/illustrates components of an autonomous PV panel cleaning system 300, in accordance with an embodiment. In an embodiment, the autonomous PV panel cleaning system 300 is herein referred to as cleaning system 300.

In an embodiment, the cleaning system 300 comprises one or more solar bots 100 for the efficient autonomous cleaning of one or more solar plants 200. The cleaning system may further comprise one or more drones 204, an IoT server 304, one or more remote controllers 306, and one or more user devices 308 which can communicate with the solar bot 100 through a communication network 302.

In an embodiment, the IoT server 304 may be used for solar plant management, viewing a solar plant dashboard, as well as fleet control and management of multiple solar bots 100 and drones 204. Further, the IoT server 304 may be used for enabling real-time connectivity, monitoring and analytics of the fleet.

In an embodiment, the solar bot 100 may use its onboard PV panel 112 to determine that a particular PV array in a solar plant 200 requires a cleaning action. In this case, the solar bot communicates a cleaning request to the IoT server 304, comprising the location, name and id of the solar bot 100 as well as the PV array which requires cleaning. The IoT server 304 may communicate with one or more drones in that solar plant 200 to determine which solar bot is in closest in distance to the vicinity of the PV array which requires cleaning. One or more onboard cameras on one or more drones 204 may be used to determine the closest solar bot 100. Thereafter, the closest solar bot 100 may be transferred to the PV array which requires cleaning, by using a drone.

In an embodiment, the remote controllers 306 may be used to provide instructions to the solar bot 100, including one or more of turning ON the solar bot 100 or brushes, turning OFF the solar bot 100 or brushes, navigating, obstacle-avoiding as well as rectifying irregular solar panel orientation.

In an embodiment, the user devices 308 may be used to access an IoT dashboard through an IoT interface on the user devices 308. The user may monitor and control the functioning of one of more solar bots 100 in one or more solar plants 200 by using the IoT dashboard. The user device may comprise one or more of a mobile phone, a smart phone, a smart watch, a tablet, a computer, a laptop, and any other device which can communicate with the cleaning system 300 through the communication network 302.

In an embodiment, the communication network 302 may comprise or enable wired and wireless communication, including but not limited to, GPS, GSM, LAN, Wi-fi compatibility. Bluetooth low energy as well as NFC.

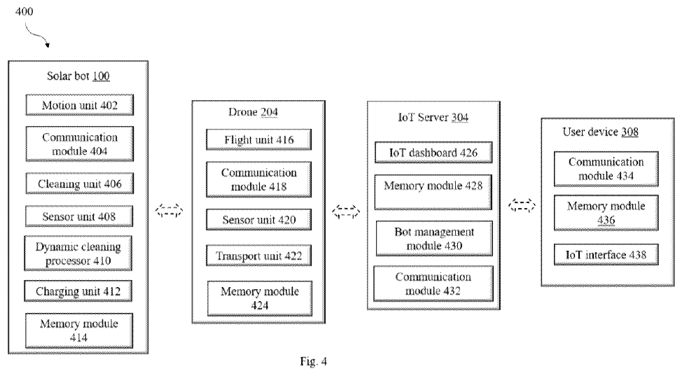

FIG. 4 depicts/illustrates block diagrams 400 depicting the components of the autonomous PV panel cleaning system 300, in accordance with an embodiment.

In an embodiment, the solar bot 100 may comprise a motion unit 402, an input/output module 404, a cleaning unit 406, a sensor unit 408, a dynamic cleaning processor 410, a charging unit 412, and a memory module 414, among others.

In an embodiment, the motion unit 402 may comprise one or more motors, gears, actuators as well as wheels such as mecanum or crawler wheels to enable the movement of the solar bot 100 over the PV panel 202.

In an embodiment, the motion unit 402 comprises at least one mecanum or crawler wheel which is driven by one or more motors comprised within the motion unit 402. Advantageously, the mecanum or crawler wheel provides superior, controlled and efficient movement over the PV panels.

In an embodiment, each mecanum or crawler wheel comprises several rollers which are rubber-coated on an outer surface, and ensure even surface load-distribution over the glass surface of the PV panel. Further, the mecanum wheel or crawler wheel also ensure that the glass surface or the ARC Coating of the PV panel is not damaged during the movement of the solar bot 100 over the PV panels.

In an embodiment, the input % output module 404 may enable communication through one or more technologies comprising wired and wireless communication, including but not limited to, GPS, GSM, LAN, Wi-fi compatibility, Bluetooth low energy as well as NFC. Further, the input/output module 404 may comprise one or more of a keyboard, keypad or touchpad input as well as a display 108 to receive one or more inputs or display one or more information to the user.

In an embodiment, the cleaning unit 406 may comprise one or more cleaning brushes, brush motors, and gears in order to clean any dust/sand/fallen objects such as leaves, droppings, etc, that may have settled on the top of the PV panels 202. The cleaning brushes may comprise soft bristles, fabric cloth or sponges which can brush away coarse dust/sand particles, and help in pushing the dust between gaps in the modules and onto the end of every row or column. When the solar bot 100 is executing a cleaning action, the brush motors are activated, which causes the bristles to rotate and brush off dust. In an embodiment, the speed of rotation of the brushes may be determined by the dynamic cleaning processor 410.

In an embodiment, the cleaning unit 406 may comprise nylon micro-fiber bristles or fabric cloth. The bristles may be of approximately 0.0008 mm, with a triangular bristle arrangement in each bristle socket within the brush. The arrangement ensures maximum bending to provide more efficient cleaning for each rotation of the cleaning brush.

In an embodiment, the sensor unit 408 may comprise one or more of camera, thermal camera, video camera, IR sensors, ultrasonic sensor, distance sensors, obstacle avoiding sensors, edge-detecting sensors, accelerometer-gyroscope-Magnetometer, rain sensor, wind sensor, radiation sensor, Inertial Measurement Unit (IMU) sensor, humidity sensor and weather sensor, among others.

In an embodiment, the radiation sensor additionally allows the determination of an amount of dust deposited on the PV panels 202 in the same environment, based on the current reading, as an increase in dust reduces the current reading.

In an embodiment, the on-board camera and thermal camera/imager may be used for surveillance and image processing to initiate a new cleaning cycle. These sensors may also be used for detection of hotspots and micro-cracks in the PV panel 202.

In an embodiment, at least one of ultra-sonic sensors, distance sensors, obstacle avoiding sensors and edge-detecting sensors are placed in a specific fashion around the periphery of the solar bot 100 such that they are triggered whenever an obstruction or a gap is sensed in the path of the solar bot 100.

In an embodiment, the solar bot 100 comprises a dynamic path tracer, which ensures efficient cleaning and re-orientation of the solar bot in case of slippage due to obstacles or adverse weather conditions. The dynamic path tracer uses one or more information collected from the ultrasonic sensors and the IMU sensors to determine whether the solar bot 100 needs to re-orient itself according to one or more edges, planes or axes of the PV panels 202. The dynamic path tracer enables the solar bot 100 to re-orient itself according to one or more of the top, bottom, left, and right edges of the PV panel 202.

In particular, in case the solar bot has slipped, run into an obstacle or is facing adverse weather conditions, the dynamic path tracer provides directions to the mecanum or crawler wheels and the brush to stabilize the solar bot 100 and transport it to a safe location such as its base position or a docking station. The dynamic path tracer processes the information from the IMU and ultrasonic sensors and determines how to drive the mecanum or crawler wheels and the rotation of the brush in order to enable the robot to efficiently travel across the PV panels 202.

In an embodiment, the brush can rotate in clockwise and anti-clockwise directions. The rotation of the brush is used to further balance, stabilize and complement the movement of the solar bot 100, as the rotation of the brush creates friction against the PV panel 202 which can be used to move the solar bot 100. The bristles of the brush may be slightly bent against the PV panel to provide a non-slip grip. Advantageously, the brushes are positioned appropriately to enable such friction in order to help in the movement of the solar bot 100.

In an exemplary embodiment, in case one or more of the wind sensor, humidity sensor, rain sensor or weather sensor have determined that it has started to rain, the solar bot will halt its cleaning action, and the brushes and at least one mecanum or crawler wheel will be used to return the solar bot 100 to its base location or docking station.

In an embodiment, even in case all wheels of the solar bot 100 lose power or malfunction, the brush along can be rotated in order to move the solar robot upwards and downwards. This provides an advantageous fail-safe in case of wheel failure.

Further, advantageously, the dynamic path tracer can achieve angular movement of the solar bot 100 across the solar panel 202, by using the mecanum or crawler wheels, brushes and IMU and at least one of the ultrasonic sensors, distance sensors, obstacle avoiding sensors or edge detecting sensors. A master gyroscope program may be used for enabling efficient and accurate edge detection as well as lateral movement of the solar bot 100, by repeatedly calling information from the IMU and at least one of the ultrasonic sensors, distance sensors, obstacle avoiding sensors or edge detecting sensors.

In an embodiment, the solar bot 100 also comprises one or more of a RBG Light 106 with Buzzer, On-Off switch. Emergency off switch, direction control 3-way toggle switch and a touch screen Display 108.

The solar bot 100 may further comprise an on-board barcode reader to tag any defective panels located by the cameras, and communicates the same for immediate operator reference, so that the PV panel 202 may be inspected, repaired or replaced.

In an embodiment, the dynamic cleaning processor 410 may enable AI-based predictive cleaning. The solar bot 100 may use a combination of data from one or more onboard weather sensors comprising the rain sensor, humidity sensor, wind sensor, radiation sensor, etc, to predetermine future cleaning cycles based on current weather condition as well as forecasts from weather application such as Google weather, Accu weather etc.

Advantageously, the predictive cleaning feature is especially useful in determining when to schedule cleaning cycles for the PV panels 202, which reduces unnecessary cleaning cycles and helps in conserving the power of the solar bot 100.

Advantageously, the solar bot 100 may also derive one or more information from the user's existing SCADA system which may include the sensors installed at the solar plant 200, in order to execute the predictive cleaning.

In an embodiment, the dynamic cleaning processor 410 comprises an elaborate master program code written in at least one of Embedded C Language and Python. and is stored on one or more onboard microprocessors. The code comprises logical instructions, bot movement and path controlling algorithms. Additionally, various other controlling algorithms are included for speed and direction control, safety, directional calibration, and brush control.

In an embodiment, the dynamic cleaning processor 410 also integrates input data from all onboard sensors such as Ultrasonic sensors, distance sensors, obstacle avoiding sensors or edge detecting sensors, and IMU sensor, and takes an appropriate action to determine the path of the solar bot 100. The dynamic cleaning processor 410 also controls and reacts to the various connected onboard components mentioned previously.

In an embodiment, the feedback from the ultrasonic sensors is used by the dynamic cleaning processor 410. The solar bot 100 may move in a particular path over the photovoltaic panels based on the feedback of the ultrasonic sensors, distance sensors, obstacle avoiding sensors or edge detecting sensors, such that the rotating brushes reach all edges of the entire PV panel 202 layout.

In an embodiment, the charging unit 412 may comprise one or more of DC charging via an onboard flexible PV panel, AC charging via regular AC supply with quick charging technology, and regenerative charging via braking and free motion control.

In an embodiment, the charging unit 412 may comprise an onboard portable Lithium battery.

An IP rated Box is placed at the center of the solar bot 100, which comprises specially designed PCBs with SMD components soldered on it, which integrates several on-board circuits that are necessary to control and move the solar bot 100. The onboard circuits comprise one or more of microprocessors, motor drivers, voltage converters and regulators, power relay circuits, circuits for internet connectivity using Wifi and sim card & IMU sensor. Further, all motors, electronics devices and sensors may be connected to the central IP rated box using multicore signal/power transmitting silicon coated and shielded wires using IP67 panel mount and wire to wire connectors.

In an embodiment, the onboard PV panel 112 may be used to determine the amount of dust gathered on the PV panels 202 in the environment of the solar plant 200. The current output reading of the onboard PV panel 112 may be monitored to determine any decrease in the current (output) reading of the onboard PV panel 112. A sudden or consistent decrease in the current reading may indicate obstructions to the PV panels, including weather changes and collection of dust on top of the onboard PV panel 112. Thus, the decrease in the current reading indicates the collection of dust/dirt on the onboard PV panel 112, from which the solar bot 100 concludes that the PV panels 202 may also be covered in dust/dirt as they are present in the same location as the solar bot 100. Thus, based on the current reading of the onboard PV panel 112, one or more cleaning actions may be scheduled by the solar bot 100.

In an embodiment, an IR sensor may be used instead of the onboard PV panel 112 for the predictive cleaning.

In an embodiment, the predictive cleaning may be AI-based, by using one or more machine leaning models that are trained with past data collected from one or more sensors. In particular, weather information from previous months or years can be fed into the AI-based predictive cleaning, in order to determine patterns in rainfall or dust collection, and accordingly predict when there may be rain or heavy dust accumulation. Further, the AI-based predictive cleaning may be used to schedule future cleaning cycles for the solar bots 100.

In an exemplary embodiment, the AI-based predictive cleaning is trained with previous year's weather data, and it determines that a particular month has regularly heavy rainfall. In this case, the AI-based predictive cleaning predicts when the next month of heavy rainfall occurs, and may instruct the solar bots 100 to not initiate any cleaning actions for that month.

In an embodiment, the memory module 414 may comprise one or more of volatile and non-volatile data storage. Further, the memory module 414 may comprise instructions for the functioning of the solar bot 100.

In an embodiment, the drone 204 may comprise a flight unit 416, a communication module 418, a sensor unit 420, a transport unit 422 and a memory module 424.

In an embodiment, the flight unit 416 may comprise one or more of propellers, batteries, motors, and connecting wires which enable the drone to fly.

In an embodiment, the communication module 418 may comprise components similar to the communication module 404 of the solar bot 100.

In an embodiment, the sensor unit 420 may comprise one or more of GPS unit, speed sensor, accelerometers, IMU sensor, tilt sensor, current and magnetic sensor, etc.

In an embodiment, the transport unit 422 may comprise one or more special carrier arms to pick up the solar bot 100 from the PV panel 200, and deposit the solar bot 100 onto a different PV panel 200

In an embodiment, the memory module 424 may comprise components similar to the memory module 414.

In an embodiment, the IoT server 304 may comprise an IoT dashboard 426, a memory module 428, a bot management module 430, and a communication module 432. The IoT dashboard 426 may allow the users to remotely monitor and control the solar bots 100 across multiple solar plant 200 sites and geographical locations.

In an embodiment, the IoT dashboard 426 may allow each user to register and create a user account. The user account may comprise one or more details comprising user name, user id, solar plant id, number of PV panels, IDs of PV panels, arrangement of PV panels, number of solar bots, number of drones, date and time of cleaning cycles, duration of cleaning cycles, and information collected by the sensor unit 408 and sensor unit 420.

In an embodiment, the IoT dashboard 426 may comprise one or more options to view each solar plant 200 and monitor the status of each solar bot 100 in the solar plant 200. Further, the IoT dashboard may provide options to modify current actions or initiate new actions for the solar bots 100. The IoT dashboard may also display information read by the sensors of the solar bot 100, as well as solar power generation data of each PV panel 202 of the solar plant 200.

In an embodiment, the memory module 428 may comprise components similar to the memory module 414. The information corresponding to each user and their user account may be stored in the memory module 414.

In an embodiment, the bot management module 430 may enable the user to initiate, modify or stop one or more actions of the solar bots 100. Additionally, the bot management module 430 may also enable the user to initiate, modify or stop one or more actions of drones 204.

In an embodiment, the communication module 432 may comprise components similar to the communication module 404 of the solar bot 100. Further, the communication module 432 may be configured to use at least one of NB-IoT, LoRa, and WiFi, among other communication/fleet management technologies.

In an embodiment, the user device 308 may comprise a communication module 434, a memory module 436, and an IoT interface 438.

In an embodiment, the communication module 434 may comprise components similar to the communication module 404 of the solar bot 100.

In an embodiment, the memory module 436 may comprise components similar to the memory module 414.

In an embodiment, the IoT interface 438 comprises a program which provides the user with an interface to view and use the IoT dashboard 426.

In an embodiment, the remote controllers 306 may comprise a communication module for communicating with the solar bot 100 and other components of the cleaning system 300, as well as input/output modules to enable the user to provide one or more instructions to the solar bot 100.

FIG. 5 depicts/illustrates an autonomous PV cleaning process with a docking station, in accordance with an embodiment.

In an embodiment, when the solar bot 100 is in OFF mode or has finished a cleaning action, the solar bot 100 may move to a base position on the PV panel 202 to wait for the next cleaning cycle.

In an embodiment, when the solar bot 100 is in OFF mode or has finished a cleaning action, the solar bot 100 may move to a docking station 502 which is attached to the PV panel 202. The docking station may be used to house the solar bot 100 when it is not in use. The docking station may protect the solar bot 100 from environmental factors such as ram, wind, dust, etc.

The figure depicts the movement of the solar bot 100 during a cleaning action. The solar bot 100 may begin from an initiate position, which could be present at the bottom of the PV panel 202, towards a left end or a right end of the solar panel 202. The figure depicts the solar bot 100 beginning from the bottom left corner of the PV panel 202. The solar bot 100 may analyze one or more information from the sensors and the AI-based prediction. Further, the solar bot 100 may move upwards till it reaches the top of an array column as shown in step 1, and moves laterally to the left to identify a first column or an intermediate gap, which is determined as a starting edge.

Thereafter, the solar bot 100 may orient itself accurately with respect to the starting edge, and may move towards the bottom of the PV panel as shown in step 2 while switching ON the brush motor for a cleaning action. As the solar bot 100 is moving downwards, the brushes rotate to clean dust from the PV panel 202.

Subsequently, once the solar bot 100 detects the bottom edge of the PV panel 202, the solar bot 100 may start moving upwards, as shown in step 3, until it reaches the top edge again. Further, the solar bot 100 may shift sideways, as shown to in step 4, until it detects the next PV panel 202 on the right.

Thereafter, the solar bot 100 may initiate further cleaning cycles comprising steps 5 to 11, after which the solar bot 100 may analyze readings from its sensors and move to the docking station 502.

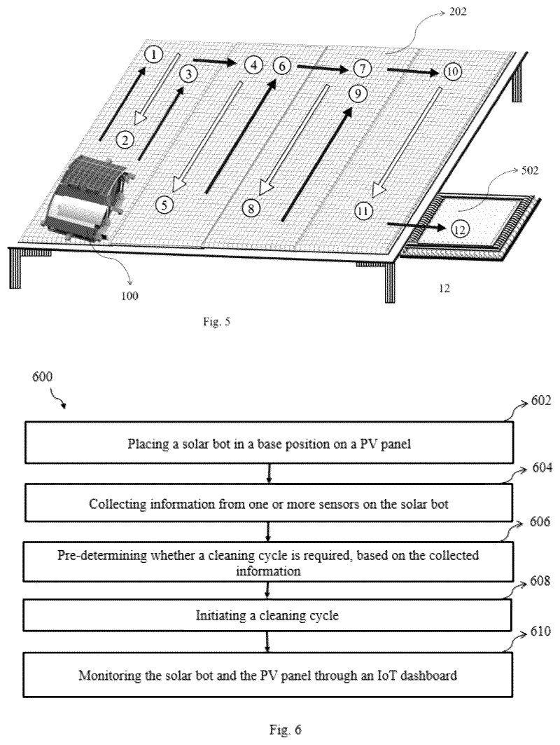

FIG. 6 illustrates a method for autonomous PV panel cleaning 600, in accordance with an embodiment. The method begins with placing a solar bot in a base position on a PV panel, as depicted at step 602. Subsequently, the method discloses collecting information from one or more sensors on the solar bot, as depicted at step 604. Thereafter, the method discloses pre-determining whether a cleaning cycle is required, by predictive cleaning based on the collected information, as depicted at step 606. Subsequently, the method discloses initiating a cleaning cycle, as depicted at step 608. The method further discloses monitoring the solar bot and the PV panel through an IoT dashboard, as depicted at step 610. Further, steps 604-610 may be repeated for completing the efficient cleaning of the PV panels in the solar plant.

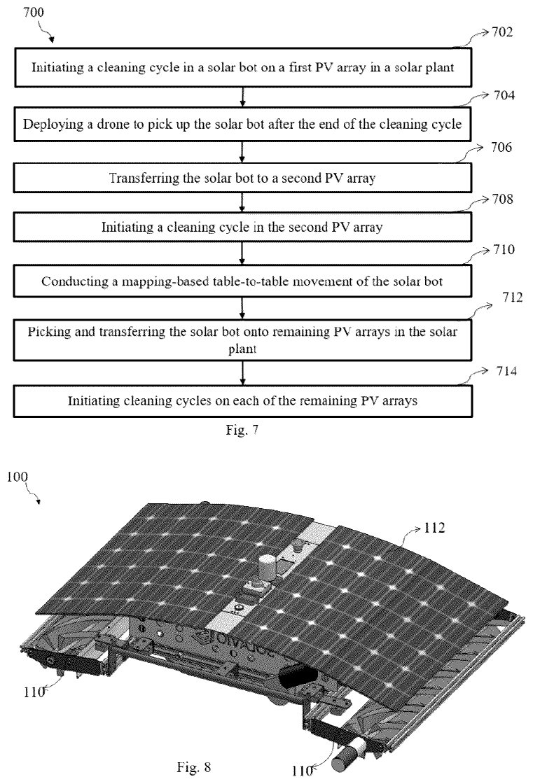

FIG. 7 illustrates a method for drone deployment 700 in a solar plant, in accordance with an embodiment. The method begins with initiating a cleaning cycle in a solar bot on a first PV any in a solar plant, as depicted at step 702. Subsequently, the method discloses deploying a drone to pick up the solar bot after the end of the cleaning cycle, as depicted at step 704. Thereafter, the method discloses transferring the solar bot onto a second PV array, as depicted at step 706. Subsequently, the method discloses Initiating a cleaning cycle in the second PV array, as depicted at step 708. The method further discloses conducting a mapping-based table-to-table movement of the solar bot, as depicted at step 710. Subsequently, the method discloses picking and transferring the solar bot onto remaining PV arrays in the solar plant, as depicted at step 712. The method further discloses initiating cleaning cycles on each of the remaining PV arrays, as depicted at step 710. Further, steps 708-712 may be repeated for completing the efficient cleaning of the PV panels in the solar plant.

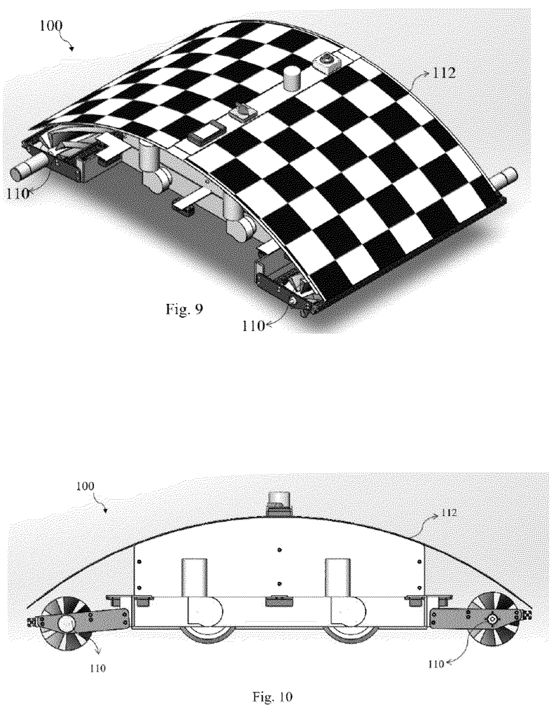

FIG. 8 depicts/illustrates an isometric view of an autonomous solar bot, in accordance with an embodiment.

FIG. 9 depicts/illustrates an isometric view of an autonomous solar bot, in accordance with an embodiment.

FIGS. 8 and 9 depict embodiments of the solar bot 100 comprising multiple brush motors 110, an onboard PV panel 112, and one or more of tower light, power switch and an emergency stop switch.

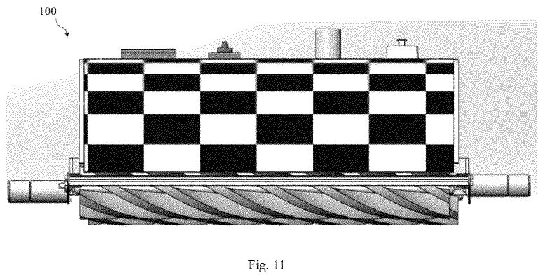

FIG. 10 depicts/illustrates a side view of an autonomous solar bot, in accordance with an embodiment.

FIG. 11 depicts/illustrates a front view of an autonomous solar bot, in accordance with an embodiment. This figure depicts the cleaning brushes as well as the tower light, power switch and an emergency stop switch.

The advantages of the current invention include providing a fully autonomous, modular solar bot which does not require any extra hardware in order to start the cleaning of the PV panels. In particular, the disclosed invention does not require the colour coding or installation of guide rails or additional frames on each PV array, which makes the disclosed invention cost-effective and easy to use.

Additionally, the solar bot comprises a dynamic path tracer, which ensures efficient cleaning and re-orientation of the solar bot in case of slippage due to obstacles or adverse weather conditions.

An additional advantage is that the solar bot is 20% more lightweight than typical bots, which allows the solar bot to clean faster. The solar bot is also more cost-efficient as well as technically advanced. The disclosed cleaning system further discloses self-charging of the solar bot through the onboard solar panel.

Applications of the current invention include cleaning of all types of solar plants, and PV panels. The modularity and portability of the solar bot makes it user-friendly, and allows it to be deployed immediately without requiring any modifications to the PV panel.

The usage of the drone allows the cleaning system to be used even in large solar plants or floating solar plants. Additionally, the fleet control using the IoT server and IoT dashboard, enable fleet control via IoT or LoRa, as well as real-time connectivity, monitoring and analytics of the fleet.

The current invention can also be used to clean other surfaces with a smooth or glass top layer. The usage of the drones allows the cleaning system to be used in any environment.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described here.

I claim:

1) An autonomous dynamic cleaning system fix cleaning PV panels (202), the autonomous dynamic cleaning system comprising:
at least one solar bot (100) for cleaning PV panels (202);
at least one IoT server (304) configured to communicate with the at least one solar bot (100); and
at least one user device (308) configured to communicate with the IoT server (100), wherein one or more of the IoT server (304) and the user device (308) are configured to remotely enable transport of the solar bot (100) across multiple solar plant (200) sites or geographical locations for cleaning PV panels (202).

2) The system as claimed in claim 1, wherein the system comprises at least one drone (204) for transporting the solar bot (100) between the PV panels (202), the drone (204) comprising:
a flight unit comprising various electronic components for enabling flight of the drone (204);
a communication module (418);
a sensor unit (420) with multiple sensors comprising one or more of GPS unit, speed sensor, accelerometers, IMU sensor, tilt sensor, current and magnetic sensor;
a transport unit (422) comprising special carrier arms to pick and place the solar bot (100) from and onto PV panels (202); and
a memory module (424) comprising instructions for effective functioning of the drone (204).

3) The system as claimed in claim 2, wherein the IoT server (304) comprises a bot management module (430) enabling a user to perform various remote actions on the solar bot (100) and drone (204), and wherein the IoT server (304) is configured to determine and transfer at least one solar bot (100) closest to the PV array based on the sensor unit (420) of the drone (204).

4) The system as claimed in claim 1, wherein the IoT server (304) comprises an IoT dashboard (426) configured to manage user accounts, display sensor information of the solar bot (100) and solar power generation data of each PV panel (202) of the solar plant (200), monitor status of each solar bot (100), and modify current actions or initiate new actions for the solar bot (100).

5) The system as claimed in claim 1, wherein the solar bot (100) further comprises:
cylindrical cleaning brushes driven by brush motors (110);
a dynamic cleaning processor (410);
a sensor unit (408) comprising multiple sensors for determining parameters to clean the PV panels (202); and
a communication module (404) enabling user interface with the solar bot (100).

6) The system as claimed in claim 5, and wherein the system comprises:
a motion unit (402) comprising at least two wheels, wherein the at least two wheels comprise mecanum, crawler or caterpillar wheels driven by motors; and
a dynamic path tracer configured to process sensor data from the sensor unit (408) to determine and instruct movements of one or more of the wheels and cleaning brushes.

7) The system as claimed in claim 6, wherein the solar bot (100) comprises a base position or docking station, wherein dynamic path tracer analyses one or more sensor data and weather data from the sensor unit (408) to determine when the solar bot (100) returns to the base position or docking station.

8) The system as claimed in claim 5, wherein the solar bot (100) comprises a dynamic cleaning processor (410) comprising an artificial intelligence based predictive cleaning which processes sensor data received from the sensor unit (408), and wherein the dynamic cleaning processor (410) determines a cleaning path of the solar bot (100) based on the artificial intelligence based predictive cleaning.

9) The system as claimed in claim 8, wherein the dynamic cleaning processor (410) is configured to determine speed of rotation of the cleaning brush motors (110) and activate the cleaning brush motors (110) to rotate in clockwise and anti-clockwise directions to enable movement of the solar bot (100) on the PV panel (202).

10) The system as claimed in claim 5, wherein the sensor unit (408) comprises one or more of camera, thermal camera, video camera, IR sensors, ultrasonic sensor, distance sensor, edge-detecting sensor, obstacle avoiding sensor, accelerometer-gyroscope-Magnetometer, rain sensor, wind sensor, radiation sensor, Inertial Measurement Unit (MU) sensor, humidity sensor and weather sensor.

11) The system as claimed in claim 1, wherein the solar bot (100) comprises a motion unit (402), where the motion unit (402) comprises:
at least two mecanum or crawler wheels driven by motors; and
a dynamic path tracer configured to determine and instruct movements of the mecanum or crawler wheels and the solar bot (100) based on sensor data from the sensor unit (408).

12) The system as claimed in claim 1, wherein the solar bot (100) comprises an onboard PV panel (112), wherein the dynamic cleaning processor (410) schedules one or more cleaning actions for the solar bot (100) based on current readings of the onboard PV panel (112).

13) A method for autonomous dynamic cleaning of PV panels (202), the method comprising:
cleaning PV panels (202) by using at least one solar bot (100);
communicating with the solar bot (100) by using one or more of at least one IoT server (304) and at least one user device (308);
transporting the solar bot (100) across multiple solar plant (200) sites or geographical locations, in a remote manner, based on one or more instructions from the IoT server (304) or the user device (308).

14) The method as claimed in claim 13, wherein the method comprises:
initiating a cleaning cycle in the solar bot (101) on the first PV array in the solar plant (200);
determining solar bot (100) closest to the PV array by using one or more of the IoT server (304) and a sensor unit (420) of at least one drone (204);
providing fleet control instructions, by using the IoT server (304), to the at least one drone (204) to transfer the closest solar bot (100) to the PV array;
picking up the solar bot (100) by using a drone comprising a transport unit (422);
deploying the drone (204) to transfer the solar bot (100) to remaining PV arrays in the solar plant (200);
initiating cleaning cycles on each of the remaining PV arrays; and
conducting a mapping-based table-to-table movement of the drone transfer of the solar bot (100).

15) The method as claimed in claim 13, wherein the method comprises:
managing user accounts;
displaying sensor information of the solar but (100) and solar power generation data of each PV panel (202) of the solar plant (200);
monitoring status of each solar bot (100); and
modifying current actions or initiate new actions for the solar bot (100), by using the IoT server (304).

16) The method as claimed in claim 13, wherein cleaning PV panels (202) by using at least one solar bot (100) comprises:
receiving sensor data from a sensor unit (408) in the solar bot (100);
receiving current readings of an onboard PV panel (112) in the solar bot (100);
processing the sensor data and the current readings by using an artificial intelligence based predictive cleaning;
determining at least one cleaning action and path of the solar bot (100) based on the artificial intelligence based predictive cleaning;
scheduling the at least one cleaning actions for the solar bot (100) by using a dynamic cleaning processor (410);
initiating a cleaning cycle based on a determined cleaning action required on the PV panel (202); and
monitoring the solar bot (100) and the PV panel (202) through an IoT dashboard (426).

17) The method as claimed in claim 16, wherein the method comprises:
receiving instructions from a remote controller (306) to initiate or modify the cleaning action of the solar bot (100);
initiating the cleaning of the PV panel (202);
monitoring and controlling the solar bot (100) across multiple solar plant (200) sites, by a user using a remote controller (306).

18) The method as claimed in claim 13, wherein the method comprises:
determining speed of rotation of the cleaning brush by using a dynamic cleaning processor (410);
enabling movement of the solar bot (100) on the PV panel (202) by rotating cleaning brush motors (110) in clockwise and anti-clockwise directions;
driving at least two mecanum or crawler wheels by motors within a motion unit (402); and
determining and instructing movements of the mecanum or crawler wheels and the solar bot (100) based on sensor data from the sensor unit (408), by using a dynamic path tracer.

19) The method as claimed in claim 13, wherein the method comprises:
monitoring a current output reading of an onboard PV panel (112) on the solar bot (100);
determining a decrease in current output reading of an onboard PV panel (112);
scheduling one or more cleaning actions for the solar bot (100) based on current readings of the onboard PV panel (112); and
cleaning PV panels (202) by using at least one solar bot (100).
